(19) United States
(12) Patent Application Publication
(10) Pub. No.: US 2016/0116705 A1
(43) Pub. Date: Apr. 28, 2016

(54) Photographic Lens Optical System

(71) Applicant: KOLEN CO., LTD., Seongnam-si (KR)

(72) Inventors: Jong Jin Lee, Seoul (KR); Chan Goo Kang, Seongnam-si (KR)

(21) Appl. No.: 14/920,522

(22) Filed: Oct. 22, 2015

(30) Foreign Application Priority Data
Oct. 28, 2014 (KR) 10-2014-0147625

(51) Int. Cl. G02B 9/60; G02B 1/04; G02B 27/00; G02B 13/00

(52) U.S. Cl. CPC G02B 9/60; G02B 13/0045; G02B 1/041; G02B 27/0025; G02B 5/208

(57) ABSTRACT

Provided is a photographic lens optical system. The photographic lens optical system includes an iris, a plurality of lenses, and a sensor configured to record images transmitted through the plurality of lenses. A second surface (light exit surface) of a lens that is the farthest from the sensor of the plurality of lenses is a flat surface. The plurality of lenses may be plastic lenses and may include first through fifth lenses sequentially arranged between a subject and the sensor, and the first and second lenses may have positive refractive power and the second, fourth, and fifth lenses may have negative refractive power. At least one surface of both surfaces of the fifth lens may have a plurality of inflection points.

### FIELD OF THE INVENTION

One or more exemplary embodiments relate to an optical system, and more particularly, to a lens optical system included in a camera.

### BACKGROUND OF THE INVENTION

Most recent cameras are digital cameras that include an image sensor, a memory, and a lens optical system. Cameras may be provided in other electronic devices such as communication devices. Charge-coupled device (CCD) or complementary metal-oxide-semiconductor (CMOS) image sensors are widely used as image sensors.

Although a resolution of a camera may be affected by a post-process of processing a captured image, the resolution of the camera may be largely affected by a pixel density of an image sensor and a lens optical system. As the pixel density of the image sensor increases, an image may be clearer and may have more natural colors. As aberrations of the lens optical system decrease, an image may be clearer and more detailed.

In order to reduce aberrations, the lens optical system includes one or more lenses. Glass lenses or plastic lenses may be used according to the camera or a device in which the camera is provided.

When the camera is provided in a device (for example, a mobile device), most lenses of the lens optical system may be plastic lenses. Thus, the camera is lightweight, the manufacturing costs of the camera are low, and the lenses may be more easily processed than glass lenses.

### SUMMARY OF THE INVENTION

One or more exemplary embodiments include a lens optical system that may maintain advantages of a conventional lens optical system and may simplify composition and a manufacturing process.

Additional aspects will be set forth in part in the description which follows and, in part, will be apparent from the description, or may be learned by practice of the presented embodiments.

According to one or more exemplary embodiments, a lens optical system includes an iris, a plurality of lenses, and a sensor that records images that are transmitted through the plurality of lenses, wherein a second surface (light exit surface) of a lens that is the farthest from the sensor of the plurality of lens is a flat surface.

The plurality of lenses may be plastic lenses, and may include first through fifth lenses that are sequentially arranged between a subject and the sensor, wherein the first and third lenses of the first through fifth lenses have positive refractive power and the second, fourth, and fifth lenses have negative refractive power.

The lens optical system may further include an infrared blocking unit that is disposed between the plurality of lenses and the sensor.

At least one surface of both surfaces of a lens that is the closest to the sensor may have a plurality of inflection points.

A central thickness D2 of the second lens and a focal length F of the lens optical system may satisfy

0.02<D2/F<1.0. <Equation 1>

A distance AL between the iris and the sensor and a distance TTL between a center of an incident surface of the first lens and the sensor may satisfy

0.8<AL/TTL<1.0. <Equation 2>

A distance TTL between a center of an incident surface of the first lens and the sensor and a diagonal length ImgH of an effective pixel region of the sensor may satisfy

0.6<TTL/ImgH<1.0. <Equation 3>

A focal length F1 of the first lens and a focal length F of the lens optical system may satisfy

1.0<F/F1<2.0. <Equation 4>

An effective viewing angle FOV of the lens optical system may satisfy

65<FOV<90. <Equation 5>

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view of a lens optical system according to an exemplary embodiment;

FIGS. 2 through 4 are diagrams of a longitudinal spherical aberration, an astigmatic field curvature, and a distortion of the lens optical system, according to a first exemplary embodiment;

FIGS. 5 through 7 are diagrams of a longitudinal spherical aberration, an astigmatic field curvature, and a distortion of the lens optical system, according to a second exemplary embodiment; and

FIGS. 8 through 10 are diagrams of a longitudinal spherical aberration, an astigmatic field curvature, and a distortion of the lens optical system, according to a third exemplary embodiment.

### DETAILED DESCRIPTION OF THE INVENTION

Reference will now be made in detail to embodiments, examples of which are illustrated in the accompanying drawings, wherein thicknesses of layers or regions are exaggerated for clarity and like reference numerals denote like elements throughout. As used herein, the term “and/or” includes any and all combinations of one or more of the associated listed items. Expressions such as “at least one of,” when preceding a list of elements, modify the entire list of elements and do not modify the individual elements of the list. A first surface of each lens is an incident surface on which light is incident and a second surface refers to an exit surface through which light is emitted.

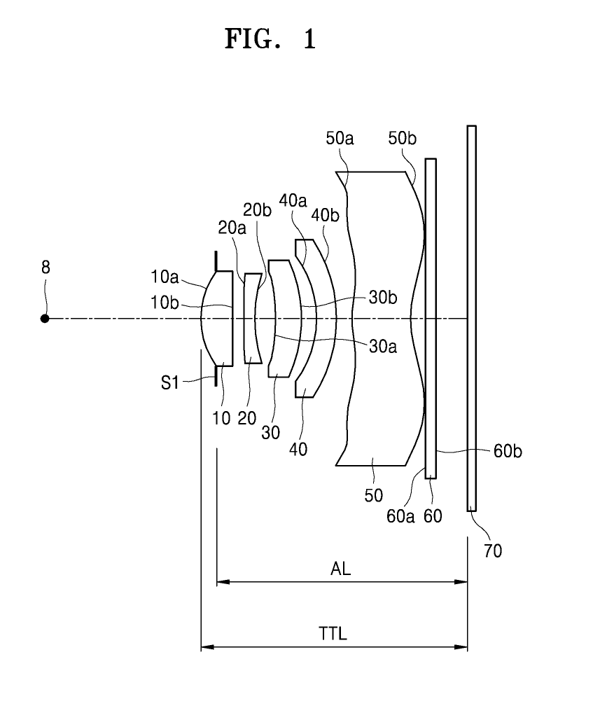

FIG. 1 is a cross-sectional view of a lens optical system (hereinafter, referred to as a first lens optical system 100) according to an exemplary embodiment.

Referring to FIG. 1, the first lens optical system 100 may include first through fifth lenses 10, 20, 30, 40, and 50 that are sequentially arranged between a subject 8 and an image sensor 70. The first through fifth lenses 10, 20, 30, 40, and 50 may be plastic lenses. The first through fifth lenses 10, 20, 30, 40, and 50 are sequentially arranged in a direction from the subject 8 to the image sensor 70. Light incident on the first lens 10 sequentially passes through the second through fifth lenses 20, 30, 40, and 50 and reaches the image sensor 70. An infrared blocking unit 60 is disposed between the fifth lens 50 and the image sensor 70. The infrared blocking unit 60 is, for example, but is not limited to, an infrared blocking filter. The infrared blocking unit 60 may have first and second surfaces 60a and 60b. The first lens optical system 100 also includes an iris S1. In a range that does not get out of the first lens optical system 100, the iris S1 may be disposed between a second surface 10b of the first lens 10 and the subject 8. For example, the iris S1 may be located around the first lens 10 to be near a first surface 10a of the first lens 10. The iris S1 may be manually or automatically adjusted to control the amount of light incident on the first lens 10. Positions of the iris S1 and the infrared blocking unit 60 may be adjusted as desired. The image sensor 70 and the infrared blocking unit 60 may be parallel to each other. The iris S1, the first through fifth lenses 10, 20, 30, 40, and 50, and the infrared blocking unit 60 may be aligned on the same optical axis. The image sensor 70 may also be on the optical axis.

The first lens 10 has positive refractive power. The first surface 10a of the first lens 10 is a convex surface toward the subject 8. The second surface 10b of the first lens 10 is a flat surface and having no curvature. That is, the second surface 10b of the first lens 10 has an infinite radius of curvature.

The second lens 20 that is the right side of the first lens 10 has negative refractive power. A first surface 20a of the second lens 20 may be a curved surface having a relatively small curvature. The first surface 20a of the second lens 20 may be convex for the subject 8. A second surface 20b of the second lens 20 may be a curved surface that is convex for the subject 8 and therefore concave for the image sensor 70.

The third lens 30 has positive refractive power. The third lens 30 is entirely convex toward the image sensor 70. That is, first and second surfaces 30a and 30b of the third lens 30 are curved surfaces that are convex toward the image sensor 70.

The fourth lens 40 has negative refractive power. The fourth lens 40 is entirely convex toward the image sensor 70. That is, first and second surfaces 40a and 40b of the fourth lens 40 are curved surfaces that are convex toward the image sensor 70.

At least one surface of the first surface 10a of the first lens 10, the second surface 20b of the second lens 20, both surfaces of the third lens 30, and both surfaces of the fourth lens 40 may be an aspheric surface.

The fifth lens 50 has negative refractive power. At least one surface of first and second surfaces 50a and 50b of the fifth lens 50 may be an aspheric surface. At least one of both surfaces of the fifth lens 50 may have at least one inflection point. For example, the first surface 50a of the fifth lens 50 may be an aspheric surface having one or more inflection points.

At a central portion of the fifth lens 50 including the optical axis, the first surface 50a and the second surface 50b of the fifth lens 50 are convex toward the subject 8. The first surface 50a has a concave portion and a convex portion between the central portion and an edge portion of the fifth lens 50. The second surface 50b has a portion that is convex toward the image sensor 70 and is located between the central portion and the edge portion of the fifth lens 50. The first surface 50a may have more inflection points than the second surface 50b. The thickest portion of the fifth lens 50 is between the central portion and the edge portion of the fifth lens 50. A thickness of the central portion (for example, a thickness of a portion through which the optical axis passes) of the fifth lens 50 may be the smallest.

The first lens 10 may have relatively strong positive refractive power. The second through fifth lenses 20, 30, 40, and 50 may function as aberration correction lenses. A part of the infrared blocking unit 60 that is the right side of the fifth lens 50 may contact the second surface 50b of the fifth lens 50.

The performance and a total focal length of the first lens optical system 100 may vary according to thicknesses, focal lengths, and positions of the first through fifth lenses 10, 20, 30, 40, and 50 that are included in the first lens optical system 100.

The first lens optical system 100 may satisfy at least one of Equations 1 through 5.

0.02<D2/F<1.0 <Equation 1>

In Equation 1, D2 is a central thickness of the second lens 20 and F is a focal length of the first lens optical system 100. Equation 1 defines a thickness of the second lens 20 with respect to a focal length of the first lens optical system 100. When a central thickness of the second lens 20 is within Equation 1, a chromatic aberration may be more effectively corrected.

0.8<AL/TTL<1.0 <Equation 2>

In Equation 2, AL is a distance between the iris S1 and the image sensor 70 on the optical axis and TTL is a distance between the center of the first surface 10a of the first lens 10 and the image sensor 70 that is measured along the optical axis.

A position of the iris S1 in the first lens optical system 100 may be defined by Equation 2. The iris S1 may be disposed on the top of the first lens 10 or may be disposed between the first lens 10 and the second lens 20. When a position of the iris S1 satisfies Equation 2, the first lens optical system 100 that is optimized may be manufactured.

0.6<TTL/ImgH<1.0 <Equation 3>

In Equation 3, ImgH is a diagonal length of an effective pixel region.

Equation 3 shows a relationship between a size of the first lens optical system 100 and aberration correction. As a value TTL/ImgH is closer to a minimum value, the first lens optical system 100 may be slimmer but aberration correction may be disadvantageous.

In contrast, when the value TTL/ImgH is closer to a maximum value, aberration correction may be advantageous but the first lens optical system 100 may be thicker.

1.0<F/F1<2.0 <Equation 4>

In Equation 4, F1 is a focal length of the first lens 10.

Equation 4 defines a focal length of the first lens optical system 100. When Equation 4 is satisfied, the first lens optical system 100 may be made compact.

65<FOV<90 <Equation 5>

In Equation 5, FOV is an effective viewing angle of the first lens optical system 100.

When the first lens optical system 100 satisfies Equation 5, the first lens optical system 100 may function as a wide-angle lens.

First through third embodiments of the first lens optical system 100 satisfying Equations 1 through 5 will now be explained.

Table 1 shows the central thickness D2 of the second lens 20 of the first lens optical system 100, the focal length F of the first lens optical system 100, the distance AL between the iris S1 and the image sensor 70, the distance TTL between the center of the first surface 10a of the first lens 10 and the image sensor 70, the diagonal length ImgH of the effective pixel region of the image sensor 70, the focal length F1 of the first lens 10, and values of Equations 1 through 5. In below Tables, units of values other than the values of Equations 1 through 5 are mm.

TABLE 1

| | D2 | F | AL | TTL | ImgH | F1 | Equation 1 | Equation 2 | Equation 3 | Equation 4 | Equation 5 |
|---|---|---|---|---|---|---|---|---|---|---|---|
| First | 0.220 | 4.398 | 4.976 | 5.270 | 6.856 | 2.924 | 0.050 | 0.944 | 0.769 | 1.504 | 75.0 |
| embodiment | | | | | | | | | | | |
| Second | 0.220 | 4.399 | 4.974 | 5.270 | 6.856 | 2.915 | 0.050 | 0.944 | 0.769 | 1.509 | 75.0 |
| embodiment | | | | | | | | | | | |
| Third | 0.226 | 4.434 | 4.998 | 5.300 | 6.856 | 2.914 | 0.051 | 0.943 | 0.773 | 1.522 | 74.3 |
| embodiment | | | | | | | | | | | |

As apparent from Table 1, the first lens optical system 100 of the first through third embodiments satisfies Equations 1 through 3.

The first through third embodiments will now be explained in more detail with reference to data of lenses in the first lens optical system 100 and the appended drawings.

Tables 2, 3, and 4 show a radius R of curvature of each of the lenses that are included in the first lens optical system 100, a distance T that is a thickness of a lens, or a distance between lenses, or a distance between adjacent elements, a refractive index Nd, and an Abbe number Vd. The refractive index Nd is a refractive index of a lens that is measured by using a D-line. The Abbe number Vd is an Abbe number of a lens for the D-line. Reference symbol * attached to a lens surface indicates that the lens surface is an aspheric surface. Units of the radius R of curvature and the distance T are mm.

TABLE 2
(First Embodiment)

| Element | Surface | R | T | Nd | Vd |
|---|---|---|---|---|---|
| Iris S1 | S1 | | — | | |
| First lens 10 | 10a* | 1.5981 | 0.6390 | 1.546 | 56.093 |
| | 10b* | Infinity | 0.0800 | | |
| Second lens 20 | 20a* | 301.8606 | 0.2200 | 1.648 | 22.434 |
| | 20b* | 3.7752 | 0.4220 | | |
| Third lens 30 | 30a* | −8.8042 | 0.5236 | 1.546 | 55.093 |
| | 30b* | −4.0160 | 0.3103 | | |
| Fourth lens 40 | 40a* | −1.9392 | 0.4032 | 1.648 | 22.434 |
| | 40b* | −2.6202 | 0.3240 | | |
| Fifth lens 50 | 50a* | 2.5766 | 1.1878 | 1.534 | 55.856 |
| | 50b* | 1.8385 | 0.3000 | | |
| Infrared blocking | 60a | Infinity | 0.2100 | 1.530 | 39.068 |
| unit 60 | 60b | Infinity | 0.6617 | | |
| Image sensor 70 | IMG | Infinity | −0.0117 | | |

When elements of the first lens optical system 100 have values of Table 2, an F-number of the first lens optical system 100 is 2.2955 and the focal length F is about 4.3980 mm.

TABLE 3
(Second Embodiment)

| Elements | Surface | R | T | Nd | Vd |
|---|---|---|---|---|---|
| Iris S1 | S1 | | — | | |
| First lens 10 | 10a* | 1.5933 | 0.6408 | 1.546 | 56.093 |
| | 10b* | Infinity | 0.0800 | | |
| Second lens 20 | 20a* | 142.8586 | 0.2200 | 1.648 | 22.434 |
| | 20b* | 3.6968 | 0.4193 | | |
| Third lens 30 | 30a* | −9.5358 | 0.5210 | 1.546 | 55.093 |
| | 30b* | −4.3033 | 0.3104 | | |
| Fourth lens 40 | 40a* | −1.9225 | 0.3966 | 1.648 | 22.434 |
| | 40b* | −2.6106 | 0.3045 | | |
| Fifth lens 50 | 50a* | 2.5614 | 1.2174 | 1.534 | 55.856 |
| | 50b* | 1.8771 | 0.3000 | | |
| Infrared blocking | 60a | Infinity | 0.2100 | 1.530 | 39.068 |
| unit 60 | 60b | Infinity | 0.6626 | | |
| Image sensor 70 | IMG | Infinity | −0.0126 | | |

When elements of the first lens optical system 100 have values of Table 3, the F-number of the first lens optical system 100 is 2.2955 and the focal length F is about 4.3987 mm.

TABLE 4
(Third Embodiment)

| Elements | Surface | R | T | Nd | Vd |
|---|---|---|---|---|---|
| Iris S1 | S1 | | — | | |
| First lens 10 | 10a* | 1.5925 | 0.6181 | 1.546 | 56.093 |
| | 10b* | Infinity | 0.0800 | | |
| Second lens 20 | 20a* | 150.5463 | 0.2257 | 1.648 | 22.434 |
| | 20b* | 3.8062 | 0.4923 | | |
| Third lens 30 | 30a* | −11.5088 | 0.4606 | 1.546 | 55.093 |
| | 30b* | −5.7265 | 0.3169 | | |
| Fourth lens 40 | 40a* | −2.0886 | 0.3551 | 1.648 | 22.434 |
| | 40b* | −2.7452 | 0.3124 | | |
| Fifth lens 50 | 50a* | 2.9446 | 1.3757 | 1.534 | 55.856 |
| | 50b* | 2.1138 | 0.3000 | | |
| Infrared blocking | 60a | Infinity | 0.2100 | 1.530 | 39.068 |
| unit 60 | 60b | Infinity | 0.5582 | | |
| Image sensor 70 | IMG | Infinity | −0.2251 | | |

When elements of the first lens optical system 100 have values of Table 4, the F-number of the first lens optical system 100 is 2.2955 and the focal length F is about 4.4341 mm.

An aspheric surface of each lens in the first lens optical system 100 according to the first through third embodiments satisfies Equation 6 that is an aspheric surface equation.

$$\begin{matrix}Z = \frac{{Y}^{2}}{R ( 1 + \sqrt{1 - ( 1 + K ) {Y}^{2} / {R}^{2}}} + {AY}^{4} + {BY}^{6} + \\ {CY}^{6} + {DY}^{10} + {EY}^{12} + {FY}^{14} + {GY}^{16} + {HY}^{18} + {JY}^{20}\end{matrix} \qquad Equation 6$$

In Equation 6, Z is a distance from an apex of each lens along the optical axis, Y is a distance in a direction that is perpendicular to the optical axis, R is the radius of curvature, K is a conic constant, and A, B, C, D, E, F, G, H, and J are aspheric coefficients.

Tables 5, 6, and 7 show the aspheric coefficients of the lenses that are included in the first lens optical system 100 according to the first through third embodiments.

TABLE 5
(Aspheric Coefficients of First Embodiment)

| Surface | K | A | B | C | D | E |
|---|---|---|---|---|---|---|
| 10a* | −0.0766 | 0.0042 | 0.0202 | −0.0473 | 0.0492 | −0.0240 |
| 10b* | — | — | — | — | — | — |
| 20a* | 0.0000 | −0.0179 | 0.0618 | −0.0316 | 0.0408 | −0.0079 |
| 20b* | −0.8573 | −0.0188 | 0.0839 | −0.0341 | −0.0151 | 0.0469 |
| 30a* | 0.0000 | −0.1153 | −0.0203 | 0.0135 | 0.0131 | 0.0374 |
| 30b* | 0.0000 | −0.0340 | −0.0761 | 0.0363 | 0.0060 | 0.0045 |
| 40a* | −13.3266 | −0.0634 | 0.0098 | −0.0206 | 0.0089 | 0.0001 |
| 40b* | −0.3775 | 0.0059 | −0.0011 | 0.0106 | −0.0043 | −0.0000 |
| 50a* | −13.4706 | −0.1070 | 0.0252 | −0.0008 | −0.0002 | −0.0000 |
| 50b* | −4.4404 | −0.0531 | 0.0139 | −0.0028 | 0.0003 | 0.0000 |

| Surface | F | G | H | J |
|---|---|---|---|---|
| 10a* | — | — | — | — |
| 10b* | — | — | — | — |
| 20a* | — | — | — | — |
| 20b* | — | — | — | — |
| 30a* | — | — | — | — |
| 30b* | — | — | — | — |
| 40a* | 0.0036 | −0.0029 | — | — |
| 40b* | 0.0004 | −0.0001 | — | — |
| 50a* | 0.0000 | 0.0000 | −0.0000 | — |
| 50b* | −0.0000 | −0.0000 | 0.0000 | −0.0000 |

TABLE 6
(Aspheric Coefficients of Second Embodiment)

| Surface | K | A | B | C | D | E |
|---|---|---|---|---|---|---|
| 10a* | −0.0743 | 0.0042 | 0.0203 | −0.0470 | 0.0484 | −0.0236 |
| 10b* | — | — | — | — | — | — |
| 20a* | 0.0000 | −0.0193 | 0.0612 | −0.0305 | 0.0436 | −0.0099 |
| 20b* | −1.3157 | −0.0200 | 0.0830 | −0.0308 | 0.0118 | 0.0497 |
| 30a* | 0.0000 | −0.1178 | −0.0195 | −0.0177 | 0.0112 | 0.0395 |
| 30b* | 0.0000 | −0.0337 | −0.0775 | 0.0351 | 0.0052 | 0.0054 |
| 40a* | −13.3761 | −0.0601 | 0.0079 | −0.0214 | 0.0097 | 0.0001 |
| 40b* | −0.3504 | 0.0074 | −0.0003 | 0.0107 | −0.0043 | −0.0001 |
| 50a* | −14.2031 | −0.1064 | 0.0254 | −0.0008 | −0.0002 | −0.0000 |
| 50b* | −4.4746 | −0.0526 | 0.0139 | −0.0028 | 0.0003 | 0.0000 |

| Surface | F | G | H | J |
|---|---|---|---|---|
| 10a* | — | — | — | — |
| 10b* | — | — | — | — |
| 20a* | — | — | — | — |
| 20b* | — | — | — | — |
| 30a* | — | — | — | — |
| 30b* | — | — | — | — |
| 40a* | 0.0035 | −0.0029 | — | — |
| 40b* | 0.0004 | −0.0001 | — | — |
| 50a* | 0.0000 | 0.0000 | −0.0000 | — |
| 50b* | −0.0000 | −0.0000 | 0.0000 | −0.0000 |

TABLE 7
(Aspheric Coefficients of Third Embodiment)

| Surface | K | A | B | C | D | E |
|---|---|---|---|---|---|---|
| 10a* | −0.0727 | 0.0028 | 0.0234 | −0.0473 | 0.0454 | −0.0220 |
| 10b* | — | — | — | — | — | — |
| 20a* | 0.0000 | −0.0195 | 0.0632 | −0.0368 | 0.0408 | −0.0043 |
| 20b* | 0.3275 | −0.0165 | 0.0817 | −0.0302 | 0.0045 | 0.0543 |
| 30a* | 0.0000 | −0.1092 | −0.0277 | −0.0146 | 0.0149 | 0.0314 |
| 30b* | 0.0000 | −0.0283 | −0.0779 | 0.0299 | 0.0034 | 0.0074 |
| 40a* | −15.2107 | −0.0478 | 0.0071 | −0.0199 | 0.0093 | −0.0008 |
| 40b* | −0.0579 | −0.0143 | 0.0041 | 0.0116 | −0.0042 | −0.0001 |
| 50a* | −18.9011 | −0.1040 | 0.0253 | −0.0008 | −0.0002 | −0.0000 |
| 50b* | −3.7892 | −0.0529 | 0.0142 | −0.0028 | 0.0003 | 0.0000 |

| Surface | F | G | H | J |
|---|---|---|---|---|
| 10a* | — | — | — | — |
| 10b* | — | — | — | — |
| 20a* | — | — | — | — |
| 20b* | — | — | — | — |
| 30a* | — | — | — | — |
| 30b* | — | — | — | — |
| 40a* | 0.0035 | −0.0022 | — | — |
| 40b* | 0.0004 | −0.0001 | — | — |
| 50a* | 0.0000 | 0.0000 | −0.0000 | — |
| 50b* | −0.0000 | −0.0000 | 0.0000 | −0.0000 |

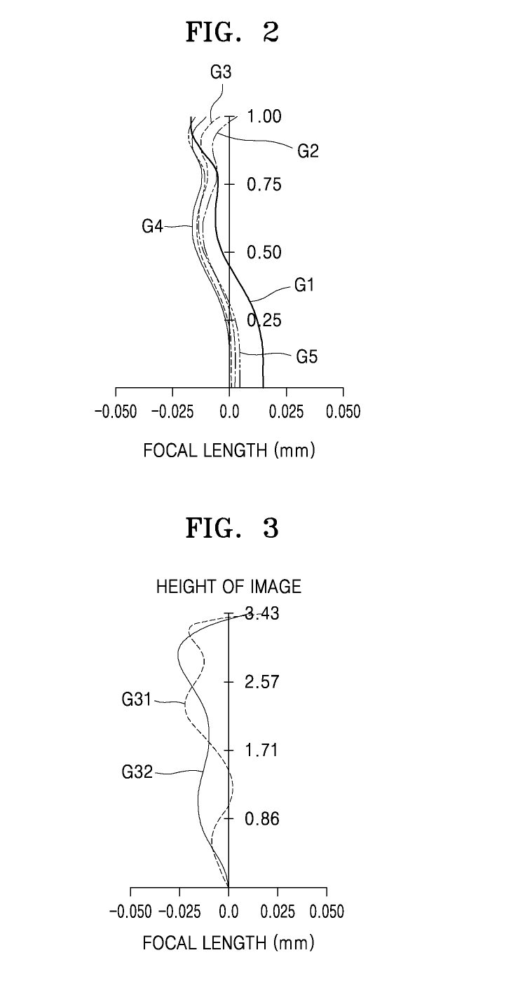

FIG. 2 is a diagram illustrating a longitudinal spherical aberration of the first lens optical system 100 when the lenses that are included in the first lens optical system 100 have values and aspheric coefficients according to the first embodiment. A first graph G1 in FIG. 2 shows a result when a wavelength of incident light is 435.8000 nm and a second graph G2 in FIG. 2 shows a result when a wavelength of incident light is 656.3000 nm. A third graph G3 shows a result when a wavelength of incident light is 587.6000 nm and a fourth graph G4 shows a result when a wavelength of incident light is 546.1000 nm. A fifth graph G5 shows a result when a wavelength of incident light is 486.1000 nm.

FIG. 3 is a diagram illustrating an astigmatic field curvature of the first lens optical system 100 when the lenses that are included in the first lens optical system 100 have values and aspheric coefficients according to the first embodiment. A result of FIG. 3 was obtained by using light having a wavelength of 546.1000 nm.

In FIG. 3, a first graph G31 shows a tangential field curvature and a second graph G32 shows a sagittal field curvature.

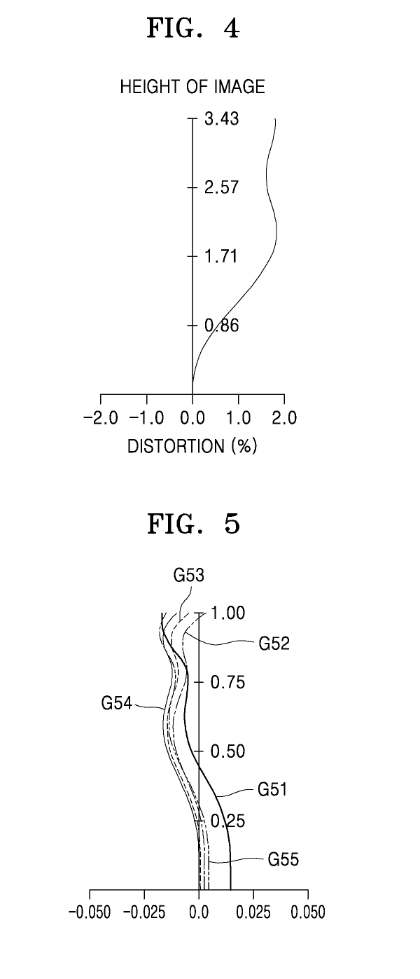

FIG. 4 is a diagram illustrating a distortion of the first lens optical system 100 when the lenses in the first lens optical system 100 have values and aspheric coefficients according to the first embodiment. A result of FIG. 4 was obtained by using light having a wavelength of 546.1000 nm.

FIGS. 5 through 7 are respectively diagrams illustrating a longitudinal spherical aberration, an astigmatic field curvature, and a distortion of the first lens optical system 100 when the lenses in the first lens optical system 100 have values and aspheric coefficients according to the second embodiment. Same light as used to obtain the result of FIG. 4 was used to obtain the results of FIGS. 5 through 7.

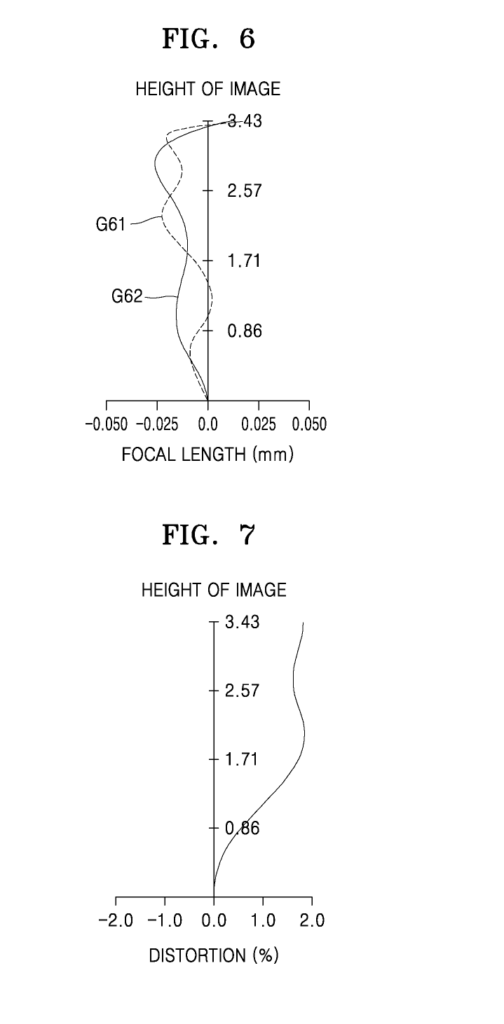

First through fifth graphs G51 through G55 of FIG. 5 correspond to the first through fifth graphs G1 through G5 of FIG. 2. First through second graphs G61 and G62 of FIG. 6 correspond to the first and second graphs G31 and G32 of FIG. 3.

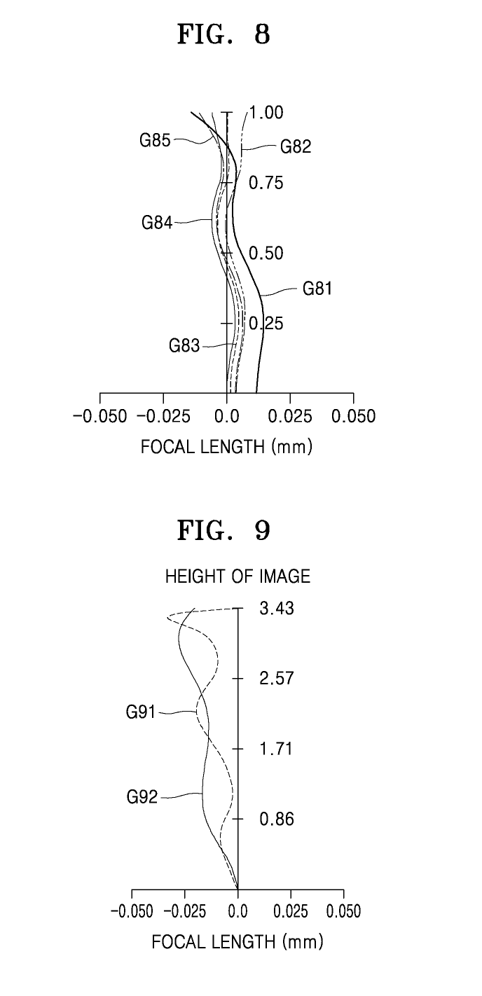

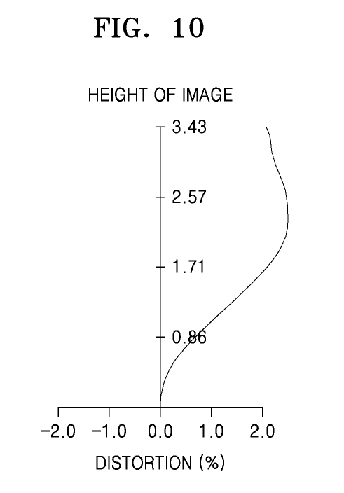

FIGS. 8 through 10 are respectively diagrams illustrating a longitudinal spherical aberration, an astigmatic field curvature, and a distortion of the first lens optical system 100 when the lenses that are included in the first lens optical system 100 have values and aspheric coefficients according to the third embodiment. Light that was used in order to obtain results of FIGS. 8 through 10 is the same as light that was used in order to obtain the results of FIGS. 2 through 4.

First through fifth graphs G81 through G85 of FIG. 8 correspond to the first through fifth graphs G1 through G5 of FIG. 2, and first and second graphs G91 and G92 of FIG. 9 correspond to the first and second graphs G31 and G32 of FIG. 3.

As shown in FIGS. 2 through 10, when the first lens optical system 100 is used, various aberrations may be corrected and reduced. Also, a total length of the first lens optical system 100 is relatively small. Accordingly, according to the one or more exemplary embodiments, the first lens optical system 100 may be made compact and may have high performance and a high resolution.

At least one surface of the first and second surfaces 50a and 50b of the fifth lens 50 in the first lens optical system 100 is an aspheric surface that has at least one inflection point between the center and the edge of the at least one surface. Accordingly, aberrations may be easily corrected by using the fifth lens 50 and also vignetting may be avoided by reducing an angle at which chief rays are emitted.

Also, since the first through fifth lenses 10, 20, 30, 40, and 50 are plastic lenses and at least one surface of the lenses is an aspheric surface, manufacturing costs may be lower than those when glass lenses are used and the first lens optical system 100 may be made compact and may have excellent performance.

Also, since the second surface 10b of the first lens 10 is a flat surface having no curvature, lens processing may be easily performed, thereby simplifying a process of manufacturing the first lens optical system 100 and increasing productivity.

The first lens optical system 100 may be applied not only to a mobile communication device but also to a recording device or a photographing device for obtaining an image of a subject.

As described above, a first lens optical system according to the one or more exemplary embodiments includes first through fifth lenses that are sequentially arranged from a subject toward an image sensor. The first and third lenses have positive power, that is, positive refractive power. The first lens may have relatively strong power. The second, fourth, and fifth lenses have negative power, that is, negative refractive power. The fifth lens may have an aspheric surface and have a plurality of inflection points, and thus may be effectively used to correct aberrations. Also, since each lens is a plastic lens and an aspheric surface is used, manufacturing costs may be lower than those when each lens is a glass lens, and a compact wide-angle lens for a high pixel density may be realized.

Furthermore, since a second surface of the first lens is a flat surface having no curvature and an indefinite radius of curvature, lens processing may be more easily performed than when the second surface is a curved surface, thereby reducing a manufacturing time and increasing productivity.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A lens optical system, comprising:
an iris;
a plurality of lenses; and
a sensor configured to record images transmitted through the plurality of lenses,
wherein a light exit surface of a lens that is the farthest from the sensor of the plurality of lens is a flat surface.

2. The lens optical system of claim 1, wherein the plurality of lenses are plastic lenses and comprise first through fifth lenses sequentially arranged between a subject and the sensor,
wherein the first and third lenses of the first through fifth lenses have positive refractive power and the second, fourth, and fifth lenses have negative refractive power.

3. The lens optical system of claim 1, further comprising an infrared blocking unit between the plurality of lenses and the sensor.

4. The lens optical system of claim 1, wherein at least one surface of both surfaces of a lens that is the closest to the sensor has a plurality of inflection points.

5. The lens optical system of claim 2, wherein a central thickness D2 of the second lens and a focal length F of the lens optical system satisfy
0.02<D2/F<1.0.

6. The lens optical system of claim 2, wherein a distance AL between the iris and the sensor and a distance TTL between a center of an incident surface of the first lens and the sensor satisfy
0.8<AL/TTL<1.0.

7. The lens optical system of claim 2, wherein a distance TTL between a center of an incident surface of the first lens and the sensor and a diagonal length ImgH of an effective pixel region of the sensor satisfy
0.6<TTL/ImgH<1.0.

8. The lens optical system of claim 2, wherein a focal length F1 of the first lens and a focal length F of the lens optical system satisfy
1.0<F/F1<2.0.

9. The lens optical system of claim 2, wherein an effective viewing angle FOV of the lens optical system satisfies
65<FOV<90.
